(19) United States
(12) Patent Application Publication
(10) Pub. No.: US 2008/0237998 A1
(43) Pub. Date: Oct. 2, 2008

(54) Gasket with high recovery half bead and wave stopper

(76) Inventors: Chingo-Ho Chen, Barrington, IL (US); Marsha Minkov, Arlington Hts., IL (US); Frank Popielas, Plainfield, IL (US); Rohit Ramkumar, Romeoville, IL (US)

Correspondence Address: MARSHALL & MELHORN, LLC, FOUR SEAGATE, 8TH FLOOR, TOLEDO, OH, 43804, US

(21) Appl. No.: 11/732,138

(22) Filed: Apr. 2, 2007

(51) Int. Cl. F02F 11/00

(52) U.S. Cl. 277/595

(57) ABSTRACT

A gasket for an engine is disclosed. The gasket may include a plate with at least one aperture formed therein, a half-bead or ramp portion formed in the plate adjacent an edge of the plate, and a wave portion or plurality of ridges formed adjacent the edge.

### FIELD

Described herein is a gasket that may be used for sealing an interface between a cylinder head and an engine block of an engine and/or that may be used for sealing an interface between a cylinder head and an exhaust manifold of an engine.

### BACKGROUND

Gaskets made of a metal material are employed for sealing an interface between a cylinder head and a cylinder block and/or an interface between a cylinder head and an exhaust manifold of an engine. Apertures in the gasket are typically provided to cooperate with combustion chambers, water passages, oil passages, exhaust gas passages or other fluid flow passages to allow fluid flow therethrough.

These gasket openings may have a structure that improves sealing around the openings.

Gaskets must withstand extreme pressure variations within and adjacent engines to prevent coolant leakage, resist rust, corrosion and, in many cases, meter fluid flow. Gaskets must also seal fluid passages extending through the engine block, the cylinder head and/or the exhaust manifold while resisting chemical reaction, allowing for lateral and vertical head movement as the engine heats and cools, and still be flexible enough to seal minor surface warpage while being stiff enough to maintain adequate gasket compression, as well as fill small machining marks that could lead to gasket leakage or failure, and withstand forces produced by engine vibration.

Further, gaskets must withstand extreme temperature variations inherent in internal combustion engine applications. During engine operation, inner edges of the cylinder head gaskets may be exposed to combustion flame temperatures from 2,000 to 3,000 degrees Fahrenheit. Accordingly, engine parts resting at subzero temperatures may be subjected to temperatures rising above 400 degrees Fahrenheit after only a few minutes of engine operation.

Known gaskets generally do not provide adequate sealing properties across the entire temperature range typical of internal combustion engine applications. As an engine warms up, thermal expansion of the engine head may create space in between the block and head and between the head and the exhaust manifold. This reduces an interface pressure applied by the cylinder head and engine block to the cylinder head gasket, thereby reducing the effectiveness of the seal provided by the gasket. The same is true regarding an interface pressure applied by the head and the exhaust manifold to the exhaust manifold gasket. After engine operation ceases, and especially during storage in cold conditions, thermal contraction of the block and head may significantly reduce space for the gasket, thereby greatly increasing pressure applied to the gasket by the block, head and/or exhaust manifold, especially at outer areas of the gasket. This may significantly reduce the ability of the metal gasket to spring back to its designed height upon thermal expansion of the engine, such as during warm-up. Further, thermal contraction of the engine block, head and/or exhaust manifold may even crush features formed in the gasket entirely. This significantly reduces the effectiveness of the gasket in sealing the head/block and the head/manifold interface. Accordingly, there is a need for a gasket which can seal the interface between an engine block and head and the interface between the head and the exhaust manifold more effectively over many engine warm-up and cool-down cycles.

### SUMMARY OF THE INVENTION

A gasket is disclosed. An illustrative embodiment of the gasket may include a plate with at least one aperture formed therein, a wave portion or plurality of ridges formed in the plate adjacent an edge of the plate, and a half-bead or ramp portion formed adjacent the edge.

### BRIEF DESCRIPTION OF THE DRAWINGS

FIG. 1 is a top view of an exemplary gasket;

FIG. 2 is an exploded section view of an exemplary multi-layer gasket;

FIG. 3 is an exploded section view of an exemplary multi-layer gasket;

FIG. 4 is a section view of an exemplary multi-layer gasket; and,

FIG. 5 is a section view of another exemplary multi-layer gasket.

### DETAILED DESCRIPTION

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

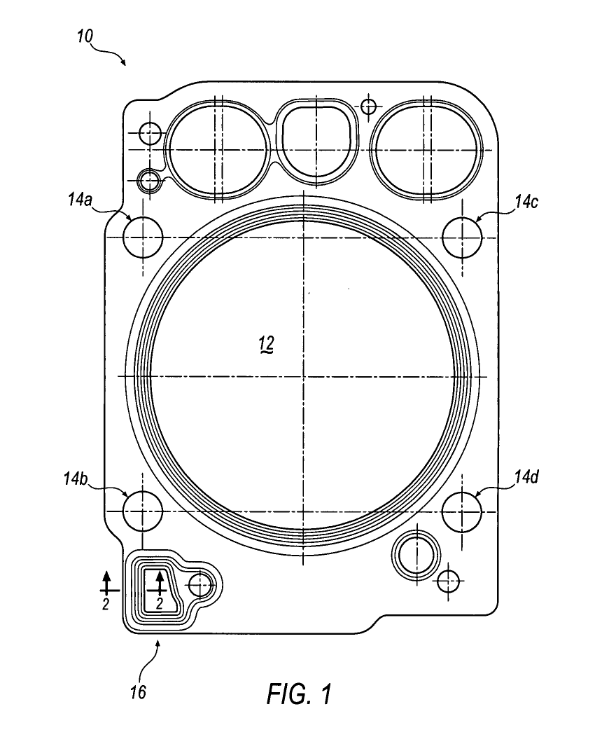

Turning now to FIG. 1, a gasket 10 adapted to seal an interface between an engine block and head (not shown in FIG. 1) is illustrated. Gasket 10 may be applied to an engine having one or more cylinder bores (not shown) formed in the cylinder block. A plurality of apertures may be provided in gasket 10, such as cylinder bore aperture 12, oil aperture 16, and bolt apertures 14a, 14b, 14c, 14d (collectively, 14). Other apertures may also be provided, such as water passage apertures. Each of apertures 12, 14, 16 may generally correspond to passages disposed in an engine block or head communicating with a passage in the head or block, respectively. Gasket 10 therefore seals an engine block and head interface, including a variety of passages communicating therebetween.

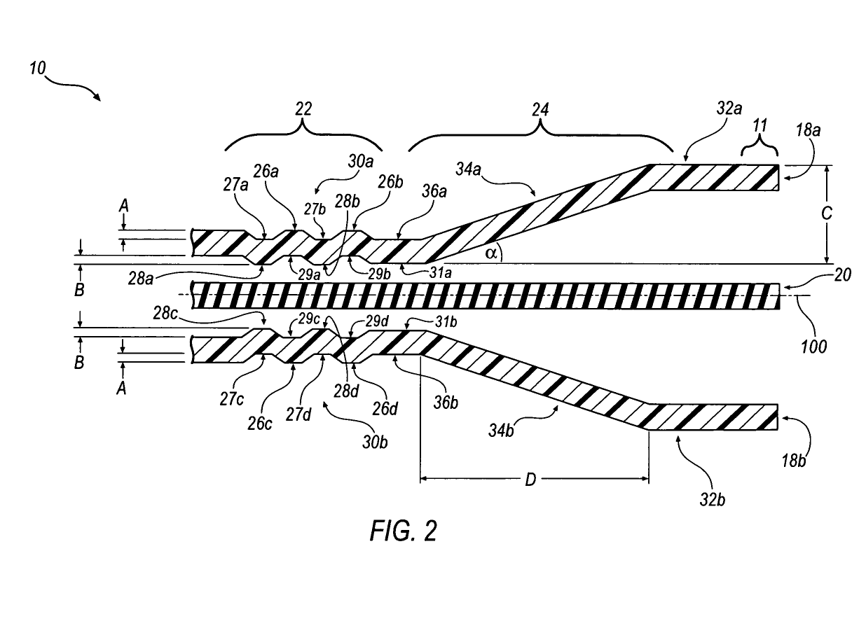

Turning now to FIG. 2, a section of gasket 10 is shown in further detail. FIG. 2 illustrates a section of gasket 10 adjacent an edge 1 1 of gasket 10. Edge 11 shown in FIGS. 2-4 may be that of an aperture in gasket 10, or a perimeter of gasket 10. Accordingly, the sections shown in FIGS. 2-4 may extend about an aperture of gasket 10, e.g., oil aperture 16, or may extend partially or entirely around a perimeter of gasket 10. Where edge 11 is adjacent an aperture, the section illustrated in FIGS. 2-4 may be employed for regions encircling any aperture of gasket 10, e.g., combustion chamber 12, bolt aperture 14, a water or coolant passage, etc. It may be particularly useful to provide the sections of FIGS. 2-4 about a perimeter of a gasket 10 for marine applications, to inhibit water intrusion.

Gasket 10 may be a Multi-Layer Steel (MLS) gasket, as generally shown in the Figures, including an upper layer 18a, an intermediate layer 20, and a lower layer 18b, wherein each of the upper and lower layers 18 are formed of a steel material. In other embodiments, gasket 10 may include additional layers, i.e., further intermediate layers and steel layers sandwiched around upper and lower layers 18.

In still other embodiments, gasket 10 may be a single layer gasket, i.e., gasket 10 includes a single layer 18, e.g., either upper layer 18a or lower layer 18b, and is provided without intermediate layer 20.

In embodiments where gasket 10 is an MLS gasket, both upper layer 18a and lower layer 18b have various features formed therein which generally correspond to features formed in the other layer. For example, as shown in FIG. 2, a plurality of ridges or wave portion 22 and a ramp or half-bead portion 24 of upper layer 18a generally corresponds to a plurality of ridges or wave portion 22 and ramp or half-bead portion 24 of lower layer 18b, such that upper layer 18a and lower layer 18b are generally mirror images of each other.

The wave portion 22 generally provides cross-sectionally projecting waves that extend along edge 11 of gasket 10, e.g., about oil passage 16. Half-bead portion 24 similarly extends along edge 11. A transition region 36, which may be generally flat, may be disposed between wave portion 22 and half-bead portion 24.

Portion 22 generally inhibits crushing of gasket 10, and in particular of half-bead portion 24, when pressure exerted upon gasket 10 is at a maximum, e.g., during cold temperature conditions. Half-bead portion 24 generally maximizes sealing of an engine block and head interface during high liftoff conditions, e.g., high temperature conditions.

The shape of the portion 22 and half-bead portion 24 may be selected from any commonly known geometric shape and may be varied to achieve uniform sealing stresses in both layers. Half-bead portion 24 may be disposed between portion 22 and edge 11, as is shown in the Figures. Alternatively, portion 22 may be disposed between half-bead portion 24 and edge 11. Gasket 10 may provide an effective seal for apertures such as oil passage 16 when half-bead portion 24 is between portion 22 and edge 11, such that half-bead portion 24 provides a primary seal about the aperture, and portion 22 generally prevents half-bead portion 24 from being crushed during high-pressure gasket conditions. Alternatively, gasket 10 may provide an effective seal for exhaust gases passing through apertures in an exhaust manifold gasket applications when portion 22 is provided between half-bead portion 24 and edge 11.

Portion 22 generally includes a plurality of ridges, waves, or undulations which project cross-sectionally away from edge 11 in each of upper and lower layers 18. Each ridge or undulation of upper and lower layers 18 may define an outer surface 26a, b, c, d (collectively, 26) for engaging engine surfaces (not shown in FIG. 2), and one or more inner surfaces 28a, b, c, d (collectively, 28) for engaging intermediate layer 20, when gasket 10 is installed in an engine. In one embodiment, as shown in FIG. 2, outer surfaces 26 and inner surfaces 28 may be generally planar, and aligned generally parallel with an axis 100 of intermediate layer 20 that extends away from edge 11. Each ridge or undulation in upper and lower layers 18 may also define a plurality of outer valley surfaces 27a, b, c, d (collectively, 27) and inner valley surfaces 29a, b, c, d (collectively, 29) which may be generally planar, and aligned generally parallel with axis 100.

Outer surfaces 26 and outer valley surfaces 27 generally define a depth A of each ridge or undulation on an outer side 30a of upper layer 18a, and an outer side 30b of lower layer 18b. Similarly, inner surfaces 28 and inner valley surfaces 29 define a depth B of each ridge or undulation on an inner side 31a of upper layer 18a and an inner side 31b of lower layer 18b. Depth A and depth B are both preferably at least 0.03 millimeters, but may be any distance greater than 0.03 millimeters that is convenient. In one embodiment, both depth A and B are about 0.07 millimeters. Depth A and B are preferably equal, but may be different. Further, material forming processes may result in slight variations between depth A and depth B.

As shown in FIG. 2, each outer surface 26 is linked with outer valley surfaces 27 by an inclined surface, such that outer surfaces 30a,b of upper and lower layers 18 define a generally trapezoidal shape. Similarly, each inner surface 28 is linked with inner valley surfaces 29 by an inclined surface, such that inner surfaces 31a,b of upper and lower layers 18 define a generally trapezoidal shape which cooperates with the generally trapezoidal shape of outer surfaces 30a,b to define the plurality of ridges included in wave portion 22.

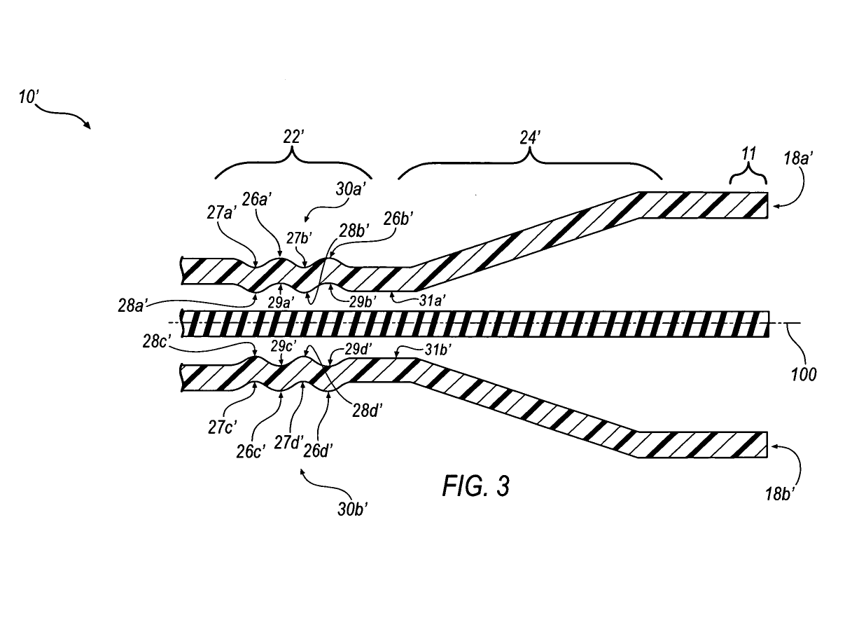

As described above, portion 22 generally prevents gasket 10 from being crushed when pressure exerted upon gasket 10 an engine block and head is at a maximum, e.g., during cold start conditions. An ability of portion 22 to resist crush may be modified by employing a larger or smaller number of ridges, or increasing or decreasing depths A and B. Further, crush resisting properties of gasket 10 may be adjusted by altering a shape of ridges included in portion 22. For example, gasket 10′ shown in FIG. 3 includes outer surfaces 26′, outer valley surfaces 27′, inner surfaces 28′, and inner valley surfaces 29′ which each have a curved shape, such that the outer and inner surfaces of each layer 18′ defines a generally sinusoidal shape. A generally sinusoidal shape may allow smoother loading during transitions from high liftoff conditions to high compression conditions, and additional flexibility in height and width adjustment, than a trapezoidal shape as described above. Alternatively, a trapezoidal shape may provide greater overall stiffness, and reduced brinelling of the gasket into engine hardware as a result of its flatter contact surfaces, than a sinusoidal shape.

As described above, half-bead portion 24 generally increases sealing capabilities of gasket 10 during high lift off conditions, e.g., high temperature conditions. Half-bead portion 24 generally includes an inclined portion 34a,b (collectively, 34) leading upward from transition regions 36 to upper regions 32a,b (collectively, 32). Alternatively, inclined portions 34 may be inclined in an opposite direction as that shown, i.e., inclined portion 34a may slope “upward” (with inclined portion 34b sloping “downward”) in FIG. 2 in a direction moving away from edge 11. This may be desirable where gasket 10 includes more than two layers. Inclined portion 34 generally defines an angle α with axis 100. In one embodiment, angle α is about 18.4 degrees. Upper region 32 generally defines a height, or offset, from transition region 36, shown as distance C. Distance C may be any distance greater than distances A and B, and is preferably at least 0.4 millimeters. In one embodiment, height C is about 0.6 millimeters. Further, inclined portion 34 generally defines a width, D. In one embodiment, width D is about 2.0 millimeters. Each of width D and height C may be varied to create a desired recovery characteristic of half-bead portion 24. Accordingly, half-bead portion 24 generally provides greater sealing pressure between an engine block and head during high-liftoff conditions than portion 22, thereby increasing effectiveness of gasket 10 at sealing an interface between an engine block and head.

MLS gasket 10 generally includes an intermediate layer 20, and may include any other number of additional layers that is convenient. Intermediate layer 20 may be formed of any known materials, including 301SS, NiZn Steel, 409SS, 201SS, and 304ss materials. Further, a thickness of intermediate layer 20 may be any thickness that is convenient, depending on the operating thickness defined by the engine block and heads (not shown), but is preferably at least 0.08 millimeters.

Other design parameters of gasket 10 may be varied to control a seal operating thickness of gasket 10. For example, a width, depth, and/or shape of portion 22 and half-bead portion 24 may be varied, as well as an overall thickness of upper and lower layers 18 and intermediate layer 20. Such control provides the ability to easily customize gasket 10 for a particular gasket application. In some known embodiments, portion 22 has a width from 1.025 millimeters (mm) to 1.06 mm. Additionally, a number of waves formed in portion 22 may be varied to adjust an overall stiffness of gasket 10. For example, increasing a number of waves formed in a given width of portion 22 may increase an overall stiffness of gasket 10, and vice versa. Additionally, gasket 10 may also include an elastomeric coating having a thickness between 0.001 millimeters and 0.05 millimeters to enhance sealing provided by gasket 10. However, thicker coatings may be used. In one embodiment, a Dana Corporation FKM coating is utilized; however, other like coatings may be employed.

Each of portion 22 and half-bead portion 24 may be formed in upper and lower layers 18 of gasket 10 by any known method. In one embodiment, portion 22 is stamped into a generally flat blank, and half-bead portion 24 is subsequently stamped into the blank. A stamping operation for forming portion 22 may be generally similar to that of a coining operation. A recovery potential of half-bead portion 24 may be generally increased by employing a greater tooling height.

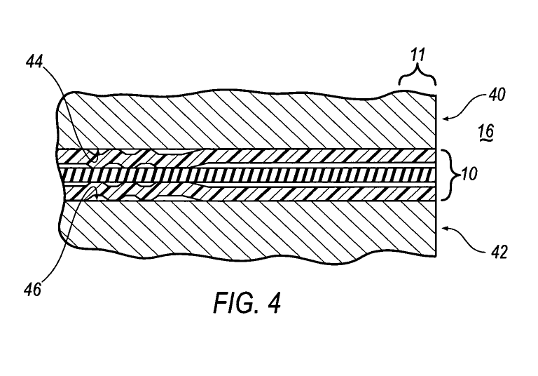

Turning now to FIG. 4, a cylinder head 40 and a cylinder block 42 of an internal-combustion engine have opposed surfaces 44, 46 that require proper sealing near edge 11. Edge 11 may be that of a cylinder bore or fluid passage, or an outer perimeter of an engine and/or gasket. Gasket 10 is held between cylinder head 40 and cylinder block 42 and generally seals clearances between the opposed surfaces 44, 46 thereof. During operation of the engine, gasket 10 is disposed between opposed surfaces 44, 46 and tightened by a clamping mechanism, as is generally known. In one embodiment, the clamping mechanism includes bolts, however, other suitable clamping mechanisms may be used.

When gasket 10 is installed, wave portion 22 and half-bead portion 24 may elastically deform in a spring-like fashion, as shown in FIG. 4. Portion 22 generally creates a uniform sealing pressure pattern throughout portion 22 where the load is desired. When engine head 40 and block 42 exert a maximum pressure upon gasket 10, e.g., during storage of the engine in cold temperature conditions, portion 22 generally resists crushing of gasket 10, and in particular of half-bead portion 24, thereby increasing springback capabilities of half-bead portion 24 when the engine transitions to a higher-liftoff condition, e.g., during engine warm-up. Accordingly, gasket 10 may provide effective sealing of an engine block/head interface during both high-liftoff and high-compression conditions.

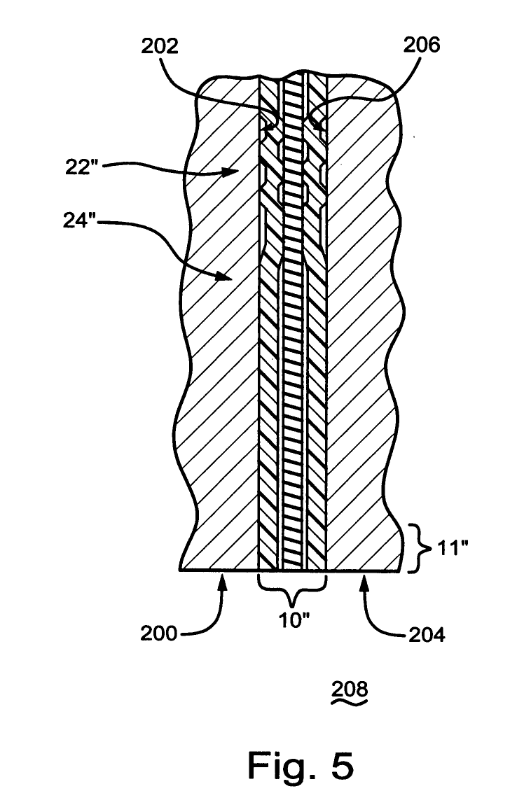

Referring now to FIG. 5, a cylinder head 200 and an exhaust manifold 202 of an internal combustion engine (not shown) are provided. As known by those skilled in the art, the cylinder head 200 may have a plurality of fluid channels extending therethrough, such as exhaust gas channels (not shown). As also known by those skilled in the art, the exhaust manifold 202 may have a complimentary number of fluid channels (not shown) aligned with the fluid channels of the cylinder head 200. A gasket 10″ is depicted as located between the exhaust manifold 202 and the cylinder head 200.

The gasket 10″ is substantially identical to gaskets 10 and 10′ described above and depicted in FIGS. 1-4. In this embodiment, however, the apertures in the gasket 10″ would have apertures complimentary in number, shape and location to match with the fluid channels in the exhaust manifold 202 and the cylinder head 200, as well as any other fluid channels or fastener apertures in the manifold 202 and head 200.

Fasteners, such as bolts, may be located through the fastener apertures to selectively secure the manifold 202 to the head 200.

The cylinder head 200 and exhaust manifold 202 have opposed surfaces 204, 206 that require proper sealing near edge 11″ of the gasket 10.″ Edge 11″ may be that of a fluid passage or an outer perimeter of the cylinder head 200 and exhaust manifold 202. Gasket 10″ is held between cylinder head 200 and exhaust manifold 202 and generally seals clearances between the opposed surfaces 204, 206 thereof.

When the gasket 10″ is installed between the cylinder head 202 and the exhaust manifold 202, wave portion 22″ and half-bead portion 24″ may elastically deform in a spring-like fashion. Portion 22″ generally creates a uniform sealing pressure pattern throughout portion 22″ where load is desired. When the cylinder head 202 and the exhaust manifold 202 exert a maximum pressure upon gasket 10″, such as during storage of the engine in cold temperatures, portion 22″ generally resists crushing of gasket 10.″ In particular, half bead portion 24″ resists such crushing, thereby increasing springback capabilities of half bead portion 24″ when the engine transitions to a higher lift-off condition, such as during engine warm up. Accordingly, gasket 10″ may provide effective sealing of a cylinder head/exhaust manifold 200, 202 interface during both high lift-off and high compression conditions.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain approaches, examples or embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A gasket for sealing about a plurality of openings comprising:
a first plate having a plurality of apertures;
a first wave portion formed in said first plate adjacent an edge of said plate; and
a first half-bead formed in said first plate adjacent said edge, said first half-bead defining a height greater than the height of said first wave portion.

2. The gasket of claim 1, wherein said edge is adjacent one of said apertures, said first wave portion and said half-bead extending about said one of said apertures.

3. The gasket of claim 1, wherein said edge is a perimeter edge of said first plate.

4. The gasket of claim 1, wherein said first half-bead is formed in said plate between said edge and said first wave portion.

5. The gasket of claim 1, wherein said first wave portion is formed in said plate between said edge and said first half-bead.

6. The gasket of claim 1, wherein said first half bead has a height of at least about 0.4 millimeters.

7. The gasket of claim 2, wherein said one of said apertures is an oil passage opening.

8. The gasket of claim 1, wherein said first plate comprises a metal material.

9. The gasket of claim 1, further comprising a second plate having a plurality of apertures generally corresponding to said plurality of apertures in said first plate, said second plate having an edge generally corresponding to said edge of said first plate, including:
a second wave portion formed in said second plate adjacent said edge of said second plate, said second wave portion generally corresponding to said first wave portion in said first plate; and
a second half-bead formed in said second plate adjacent said edge of said second plate, said second half-bead generally corresponding to said first half-bead in said first plate.

10. The gasket of claim 9, wherein said second plate includes a metal material.

11. The gasket of claim 9, further comprising an intermediate layer disposed between said first plate and said second plate.

12. The gasket of claim 1, wherein said first wave portion defines a generally sinusoidal shape.

13. The gasket of claim 1, wherein said first wave portion defines a generally trapezoidal shape.

14. A gasket, comprising:
a first metal plate having an aperture formed therein;
a first plurality of ridges formed in said first metal plate adjacent an edge of said first metal plate; and
a first ramp formed in said first metal plate adjacent said edge, said first ramp having a height greater than the height of said first plurality of ridges.

15. The gasket of claim 14, wherein said edge is adjacent said aperture of said first plate, said first plurality of ridges and said first ramp extending about said aperture of said first plate.

16. The gasket of claim 14, wherein said edge is a perimeter edge of said first metal plate.

17. The gasket of claim 14, wherein said first ramp is formed in said plate between said edge and said first plurality of ridges.

18. The gasket of claim 14, wherein said first plurality of ridges is formed in said plate between said edge and said first ramp.

19. The gasket of claim 14, wherein said first ramp has a height of at least 0.4 millimeters.

20. The gasket of claim 15, wherein said aperture is an oil passage opening.

21. The gasket of claim 14, further comprising a second metal plate having an aperture generally corresponding to said aperture in said first metal plate including:
a second plurality of ridges formed in said second metal plate adjacent an edge of said second metal plate, said second plurality of ridges generally corresponding to said first plurality of ridges in said first plate; and
a second ramp formed in said second metal plate adjacent said edge of said second metal plate, said second ramp generally corresponding to said first ramp in said first plate.

22. The gasket of claim 21, further comprising an intermediate layer disposed between said first metal plate and said second metal plate.

23. The gasket of claim 14, wherein said plurality of ridges defines a generally sinusoidal shape.

24. The gasket of claim 14, wherein said plurality of ridges defines a generally trapezoidal shape.

25. A gasket, comprising:
a metal plate defining an aperture;
a plurality of ridges formed in said plate adjacent an edge of said metal plate, said ridges defining an upper surface and a lower surface, said upper and lower surfaces defining a first height; and
a ramp formed in said plate adjacent said edge, said ramp defining an upper portion and a lower portion, said upper and lower portions defining a second height;
wherein said second height is greater than said first height.

26. The gasket of claim 25, wherein said edge is adjacent said aperture, said plurality of ridges and said ramp extending about said aperture.

27. The gasket of claim 25, wherein said edge is a perimeter edge of said metal plate.

28. The gasket of claim 25, wherein said ramp is formed in said plate between said edge and said plurality of ridges.

29. The gasket of claim 25, wherein said plurality of ridges is formed in said plate between said edge and said ramp.
